(19) United States
(12) Patent Application Publication
(10) Pub. No.: US 2013/0102067 A1
(43) Pub. Date: Apr. 25, 2013

(54) CELL MONITORING BY MEANS OF SCATTERED LIGHT MEASUREMENT

(71) Applicants: Peter Ertl, Wien (AT); Oliver Hayden, Herzogenaurach (DE); Kriemhilt Roppert, Totzenbach bei Kirchstetten (AT); Sandro Francesco Tedde, Erlangen (DE)

(72) Inventors: Peter Ertl, Wien (AT); Oliver Hayden, Herzogenaurach (DE); Kriemhilt Roppert, Totzenbach bei Kirchstetten (AT); Sandro Francesco Tedde, Erlangen (DE)

(21) Appl. No.: 13/806,505

(22) PCT Filed: Apr. 5, 2011
(86) PCT No.: PCT/EP2011/055249

§ 371 Date: Dec. 21, 2012

(30) Foreign Application Priority Data
Jun. 24, 2010 (DE) 10 2010 024 964.5

(51) Int. Cl. G01N 21/47

(52) U.S. Cl. CPC G01N 21/47
USPC 435/288.7

(57) ABSTRACT

A device for monitoring test cells has at least one receiving unit for the test cells and a first measuring unit for cell measurement. With a second measuring unit, which has a light source and a scattered light detector, cell monitoring can be carried out during the cell measurement. For this purpose the receiving unit has an at least partially light-permeable substrate and is arranged between the light source and scattered light detector such that at least a part of the light generated by the light source shines on the receiving unit, is scattered on the test cells and, after leaving the receiving unit through the substrate, impinges on the scattered light detector.

### CROSS REFERENCE TO RELATED APPLICATIONS

This application is based on and hereby claims priority to International Application No. PCT/EP2011/055249 filed on Apr. 5, 2011 and German Application No. 10 2010 024 964.5 filed on Jun. 24, 2010, the contents of which are hereby incorporated by reference.

### BACKGROUND

The present invention relates to a device for monitoring cells.

In principle, various methods and processes are known in the field of cell measurement, by which biological and chemical parameters are determined which, in medicine, for example serve for testing medicaments. In-vitro cell tests comprise marker-free methods, for example measuring the adherence of cells by impedance spectroscopy, determining oxygen by a Clark electrode or by optical sensors, and measuring the pH by ion-selective field-effect transistors. Fluorescence and chemiluminescence methods are also known. These are part of the so-called end-point determinations and are disadvantageous in that they are usually accompanied by cell kill.

The method of flow cytometry uses light scattering and fluorescence to measure cell sizes and cell structures. A disadvantage of this method is that, as a result of the sample flow, only a snapshot is granted and the samples are not characterized over a relatively long period of time.

It is known that it is necessary to monitor the cell state and the cell density of a layer of cells on a substrate during a cell measurement, particularly over a relatively long period of time. To this end, use is made of microscopic monitoring. Microscopic monitoring requires a manual work-process step or complicated automation. Continuous microscope monitoring has the disadvantage of large amounts of data, long time requirements and complicated parallelization.

### SUMMARY

It is one potential object to provide an improved device for cell measurement, by which, in particular, complicated microscope monitoring or an additional manual work-process step is avoided.

The inventors propose a device that serves to monitor cells and comprises at least one receiving unit for a plurality of test cells, and a first measuring apparatus for cell measurement. The receiving unit comprises an at least partly light-transmissive substrate. The device comprises a second measuring apparatus for scattered-light measurement. The second measuring apparatus has a light source and a scattered-light detector. Here, the receiving unit, the light source and the scattered-light detector are arranged such that at least some of the light generated by the light source shines on the receiving unit and is scattered at at least some of the test cells in the receiving unit, leaves the receiving unit through the substrate and impinges on the scattered-light detector. The advantage of this is that it is possible to monitor continuously the cell state and the cell density of a layer of test cells in parallel with a cell test, even over long periods of observation. The device according to the invention permits a combination of cell monitoring and cell measuring, e.g. an electrochemical characterization. There is no need for either an imaging method or a microscopy step, as a result of which cell monitoring becomes simpler and therefore also more cost effective. Moreover, time is saved as a result of avoiding an additional manual work step.

In an advantageous embodiment, the device comprises a scattered-light detector with at least one photodiode. The device enables the combination of a plurality of objects: the determination of the cell density, the determination of the cell morphology, the determination of concentration or density of test cells on a substrate and the determination of dynamic parameters such as growth curves, confluence of the cells and a continuous determination of acute-toxic parameters, which can more particularly be performed at the same time. The device is expediently integrated on a chip. In one embodiment, the photodiode of the scattered-light detector is arranged such that it lies outside of the light impinging on the scattered-light detector, which penetrates without scattering through the receiving unit with the test cells and the substrate. The advantage of this is that there is no need for an optical filter for the unscattered light and, as a result of this, the design can be implemented in a very simple and cost-effective manner.

In an alternative embodiment of the device, the second measuring apparatus comprises an optical filter, which is arranged between the receiving unit and the scattered-light detector. In particular, the optical filter can be matched to the wavelength of the light generated by the light source, which allows the photodiode to be arranged in the direct irradiation direction. It is advantageous if the absorbance of the optical filter depends on the angle of incidence of the light. In particular, the optical filter can be an interference filter. It is expedient to use an optical filter if the photodiode lies centrally in a region of the scattered-light detector covered by light scattered at the test cells. Then it is advantageous if the extent of the surface of the photodiode is greater than the region of the substrate covered by the light shining on the receiving unit and more particularly greater than the substrate.

The substrate is interchangeable in a further advantageous embodiment. In particular, the whole receiving unit can be embodied to be interchangeable. By way of example, the receiving unit is a microtiter plate. Such embodiments of the device are advantageous in that it allows the use of cost-effective substrates. In particular, microtiter plates are available as bulk goods. Interchangeable substrates or interchangeable receiving units are furthermore advantageous in that they simplify the device and measurements undertaken therewith. A higher throughput is also made possible.

The receiving unit can alternatively be embodied as microfluidic channel. This embodiment allows the test cells to be supplied with nutrient solution, which is advantageous, particularly over a relatively long measurement period.

The receiving unit expediently forms part of the first measuring apparatus for cell measurement and the substrate is embodied as sensor electrode. This embodiment is advantageous in that the same test cells are simultaneously characterized electronically or electrochemically and can be detected and monitored by scattered light.

In an advantageous embodiment, the second measuring apparatus and the receiving unit can be displaced relative to one another. Hence it is possible to scan all test cells. Large-area substrates enable a high throughput of test cells. Alternatively, it is only the light source that can be displaced relative to a fixed receiving unit and a fixed scattered-light detector. The scattered-light detector may comprise segmented photodiodes.

It is advantageous if the first measuring apparatus comprises at least one electrode for electrochemical analysis of the test cells. Alternatively, or else additionally thereto, the first test apparatus can comprise at least one ion-selective electrode. Furthermore, the first measuring apparatus can, alternatively or else additionally, comprise at least one electrode for measuring the impedance of the test cells. Such electrodes are integrated in the substrate of the receiving unit in an advantageous embodiment. By way of example, the substrate can be a test chip.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a side view of an embodiment of the device,

FIG. 2 shows a plan view of the further embodiment of the device,

FIG. 3 shows a side view of a further embodiment of the device,

FIG. 4 shows a further embodiment of the receiving unit and the scattered-light detector, and also a displaceable light source,

FIG. 5 shows a further embodiment of the receiving unit,

FIG. 6 shows a side view of test cells on a substrate,

FIG. 7 shows a plan view of test cells on a substrate,

FIG. 8 shows a side view of test cells on a substrate, and

FIG. 9 shows a plan view of test cells on a substrate.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

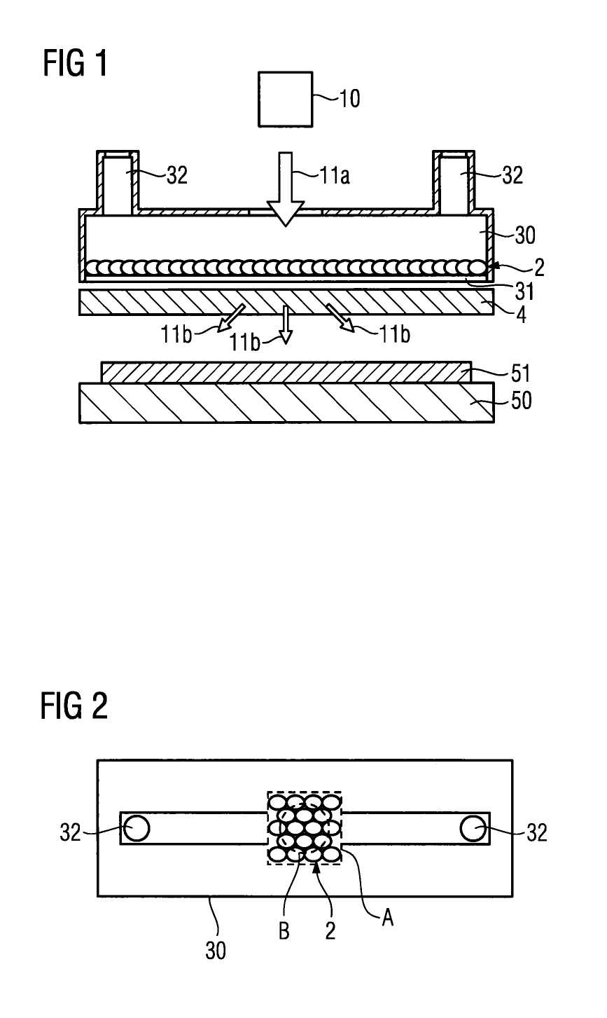

A device for monitoring cells is provided, which comprises two measuring apparatuses. The first measuring apparatus serves for cell measurement and comprises a receiving unit 30 for a plurality of test cells 2. FIG. 1 shows the receiving unit 30 in the form of a microfluidic channel, as shown in the plan view of FIG. 2. It has at least one inlet 32 and an outlet 32 for the test medium, i.e. the test cells 2. The transparent substrate 31 is covered by a sufficiently closely packed monolayer of test cells 2, as can be identified particularly clearly in FIG. 7. The embodiment of the receiving unit 30 as microfluidic channel allows a continuous supply of nutrient solution for the test cells 2. FIG. 1 furthermore shows a scattered-light detector 50 with a single large-area photodiode 51. The plan view in FIG. 2 shows that the extent A of the photodiode 51 is greater than the substrate 31 covered by test cells 2. The side view 51 in FIG. 1 shows that the receiving unit 30 and scattered-light detector 50 are arranged horizontally, with the receiving unit 30 above the scattered-light detector 50. Situated above the receiving unit 30 is a light source 10. The light source 10 emits coherent monochromatic light. A laser-light source is expedient. The side view of FIG. 1 furthermore shows light 11a which shines perpendicularly on the receiving unit and leaves the receiving unit 30 through the substrate 31 after being scattered at the test cells 2. The substrate 31 is embodied such that it is transmissive to light from the light source 10. The scattered light 11b leaves the receiving unit and forms a scattered-light cone. The latter is completely covered by the sufficiently large-area photodiode 51 of the scattered-light detector 50. An optical filter 4 is situated between the horizontal arrangement of the receiving unit 30 and the scattered-light detector 50, above the latter. The absorbance of the filter depends on the angle of incidence of the light. As a result of this, it is possible to filter out directly transmitted light from the light source, which was not scattered at the test cells 2. The embodiment of the receiving unit 30 as microfluidic channel enables the integration of the device on a test chip. Alternatively, an in-vitro test chip is integrated within the microfluidic channel.

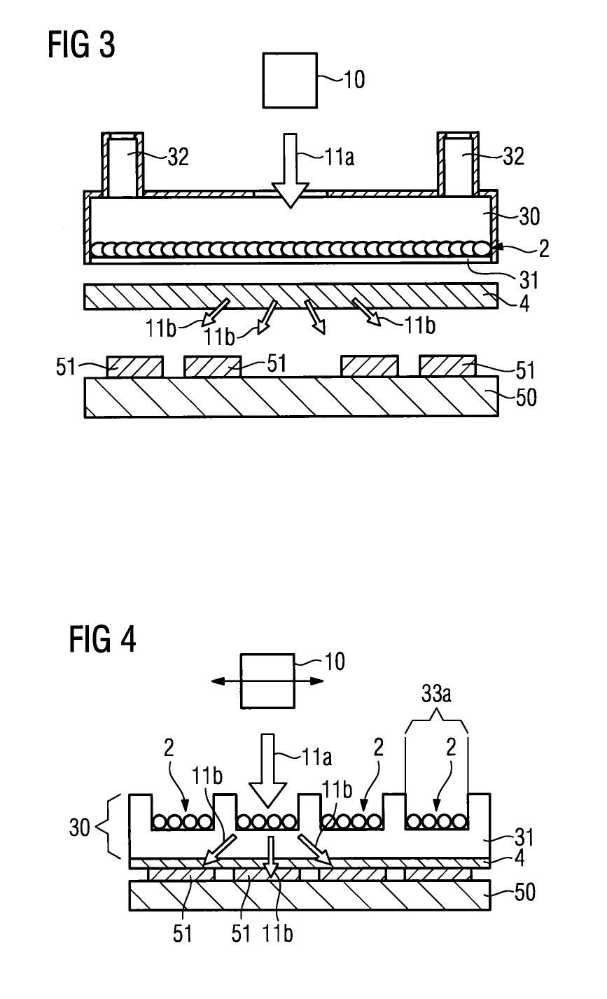

FIG. 3 shows a side view of a further embodiment. Here, the receiving unit 30, the optical filter 4 and the scattered-light detector 50 are once again mounted horizontally above one another. A light source 10 is mounted above the receiving unit 30 and it emits a directed light beam 11a with a defined beam diameter. The beam diameter is selected to be smaller than the extent A of a single photodiode 51 of the scattered-light detector 50. The scattered-light detector 50 has a plurality of photodiodes 51. These are mounted on the scattered-light detector 50 in a regular grid. In the direct transmission direction of the light beam there is no photodiode 51. This arrangement permits the use of more cost-effective optical filters 4 with a lower filter effect. The receiving unit comprises an inlet and outlet 32 for the test cells 2, a necessary nutrient solution or, in general, a test medium. The test cells 2 form a closely packed monolayer on the substrate 31. The substrate 31 is a transparent chip with one or more integrated sensors, for example a Clark electrode, an electrode for measuring the pH-value and interdigital structures for measuring the impedance for determining the adherence of the test cells 2.

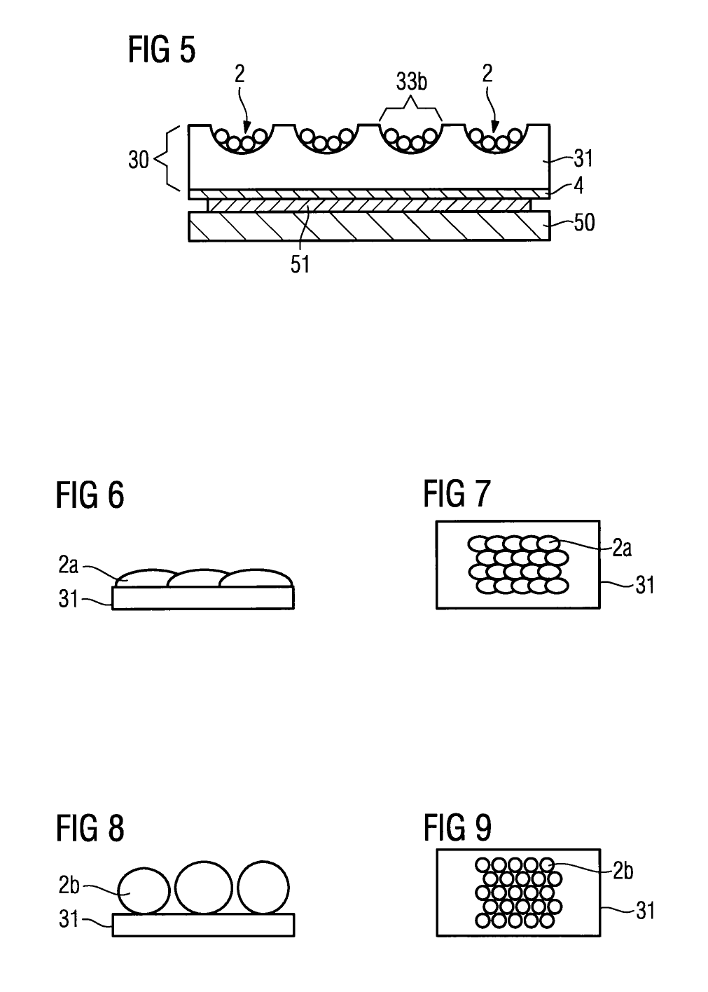

FIG. 4 shows a further embodiment, here specifically various embodiments of the receiving unit 30. Once again, receiving unit 30 and scattered-light detector 50 are arranged horizontally above one another. A displaceable light source 10 is situated above the receiving unit 30. The light source 10 can be routed over the whole substrate 31. The scattered-light detector 50 can have a single, large-area photodiode 51, as shown in FIG. 1 and FIG. 5, or it can have a plurality of segmented photodiodes 51, as shown in FIG. 3 and FIG. 4. In the case of the segmented photodiodes 51, the beam diameter of the incident light, i.e. the region B covered by the incident light, is smaller than the extent A of the photodiodes 51, see FIG. 2. The extent A of the photodiodes 51 should, independently of the light cone, be selected to be so large that a sufficient number of scattering cells 2 are covered. The receiving unit 30 is embodied as microtiter plate. The microtiter plate, i.e. the receiving unit 30 itself, therefore also forms the substrate 31. Commercially available microtiter plates offer different well shapes. The side views in FIGS. 4 and 5 show wells 33a with a planar substrate base and wells 33b which constitute hemispherical depressions in the substrate 31. An optical filter 4 is mounted between the receiving unit 30 and the scattered-light detector 50. The optical filter 4 lies directly on the scattered-light detector 50. The receiving unit 30 in turn lies directly on the optical filter 4. The receiving unit 30, embodied as microtiter plate, is interchangeable. By way of example, instead of a movement of the light source 10, it is also possible to displace the receiving unit 30 and/or the scattered-light detector 50.

FIG. 6 shows a side view and FIG. 7 shows a plan view of a substrate 31 occupied by test cells. Confluent test cells 2a form a closely packed monolayer on the substrate 31. The plan view in FIG. 9 shows that rounded cells 2a, as illustrated in FIG. 8, by contrast do not form a closely packed monolayer.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. D/RECTV, 69 USPQ2d 1865 (Fed. Cir. 2004).

1-15. (canceled)

16. A device for monitoring cells, comprising:
a receiving unit to receive a plurality of test cells, the receiving unit comprising an at least partly light-transmissive substrate;
a first measuring apparatus to measure the test cells;
a second measuring apparatus for scattered-light measurement of the test cells, comprising a light source and a scattered-light detector, wherein the receiving unit, the light source and the scattered-light detector are arranged such that at least some of the light generated by the light source shines on the receiving unit, is scattered by at least some of the test cells in the receiving unit, leaves the receiving unit through the substrate and impinges on the scattered-light detector.

17. The device as claimed in claim 16, wherein the scattered-light detector comprises a photodiode.

18. The device as claimed in claim 17, wherein the photodiode of the scattered-light detector is arranged such that it lies outside of a direct path of light from the light source, through the receiving unit without being scattered by test cells.

19. The device as claimed in claim 16, wherein the second measuring apparatus comprises an optical filter, which is arranged between the receiving unit and the scattered-light detector.

20. The device as claimed in claim 19, wherein
the filter is an interference filter, and
the interference filter has an absorbance that depends on an incidence angle of light.

21. The device as claimed in claim 19, wherein the photodiode lies centrally in the scattered-light detector such that the light source, the test cells receiving light from the light source, and the photodiode are in direct linear alignment.

22. The device as claimed in claim 19, wherein
the substrate of the receiving unit has an illuminated area where test cells receive light shining from the light source, and
the photodiode has a surface area greater than the illuminated area of the substrate.

23. The device as claimed in claim 16, wherein the substrate is interchangeable.

24. The device as claimed in claim 16, wherein
the receiving unit is a microtiter plate, and
the microtiter plate is interchangeable.

25. The device as claimed in claim 16, wherein the receiving unit is embodied as microfluidic channel.

26. The device as claimed in claim 16, wherein
the substrate of the receiving unit forms part of the first measuring apparatus, and
the substrate is embodied as sensor electrode.

27. The device as claimed in claim 16, wherein the second measuring apparatus and the receiving unit are movably mounted relative to one another.

28. The device as claimed in claim 16, wherein the first measuring apparatus comprises at least one electrode for electrochemical analysis of the test cells.

29. The device as claimed in claim 16, wherein the first measuring apparatus comprises at least one ion-selective electrode.

30. The device as claimed in claim 16, wherein the first measuring apparatus comprises at least one electrode for measuring impedance of the test cells.
